(19) United States
(12) Patent Application Publication
(10) Pub. No.: US 2013/0185010 A1
(43) Pub. Date: Jul. 18, 2013

(54) MEASUREMENT COORDINATE CORRECTION METHOD AND COORDINATE MEASURING APPARATUS

(71) Applicant: MITUTOYO CORPORATION, Kanagawa (JP)

(72) Inventors: Mitsuru FUKUDA, Koyama-shi, (JP); Kazumi MIZUKAMI, Moka-shi, (JP); Hirotada ANZAI, Utsunomiya-shi (JP); Noritsugu ONO, Utsunomiya-shi (JP)

(73) Assignee: MITUTOYO CORPORATION, Kanagawa (JP)

(21) Appl. No.: 13/729,187

(22) Filed: Dec. 28, 2012

(30) Foreign Application Priority Data
Jan. 13, 2012 (JP) 2012-005309

(51) Int. Cl. G01B 5/008; G06F 15/00

(52) U.S. Cl. CPC G01B 5/008; G06F 15/00
USPC 702/95

(57) ABSTRACT

A measurement coordinate correction method correcting the measurement coordinates of a work piece placed on a base, in which the measurement coordinate correction method includes a weight acquiring step, a position acquiring step, and a correcting step. The weight acquiring step acquires information related to the weight of the work piece. The position acquiring step acquires information related to the position of the work piece on the base. The correcting step corrects the measurement coordinates of the work piece based on the weight and position of the work piece.

### CROSS-REFERENCE TO RELATED APPLICATIONS

The present application claims priority under 35 U.S.C. §119 of Japanese Application No. 2012-005309, filed on Jan. 13, 2012, the disclosure of which is expressly incorporated by reference herein in its entirety.

### BACKGROUND OF THE INVENTION

1. Field of the Invention

The present invention relates to a measurement coordinate correction method and a coordinate measuring apparatus.

2. Description of Related Art

Conventionally, a measurement coordinate correction method has been offered as a method for improving degradation in measurement accuracy in a coordinate measuring apparatus accompanying deformation of a base when a weighty work piece is placed on the base (see, for example, Japanese Patent Laid-open Publication No. 2005-214943). The measurement coordinate correction method of Japanese Patent Laid-open Publication No. 2005-214943 includes steps (1) to (3) below:

(1) A step where, when various kinds of weighty work pieces have been placed on the coordinate measuring apparatus, a geometric error of the coordinate measuring apparatus is gauged, correction parameters are obtained from the gauged results for each work piece weight, and the correction parameters are stored in a memory.

(2) A step where the weight of the work piece to be measured is input.

(3) A step where the correction parameters corresponding to the weight of the work piece input in step (2) are read from the memory and the measurement coordinates of the work piece to be measured are corrected.

The way a base deforms when a weighty work piece is placed thereon depends on the weight of the work piece, and also depends on a position of the work piece on the base. However, in the measurement coordinate correction method of Japanese Patent Laid-open Publication No. 2005-214943, attention is paid only to the weight of the work piece and measurement coordinates for the work piece to be measured are corrected with correction parameters corresponding exclusively to the weight of the work piece. Specifically, when the position of the work piece on the base varies, the way the base deforms also varies. Thus, because the measurement coordinates are corrected with the correction parameters corresponding exclusively to the weight of the work piece, measurement accuracy may not be sufficiently improved.

### SUMMARY OF THE INVENTION

A non-limiting feature of the present invention provides a measurement coordinate correction method capable of improving measurement accuracy, and a coordinate measuring apparatus.

The measurement coordinate correction method of the present invention is a measurement coordinate correction method correcting measurement coordinates of a work piece placed on a base. The measurement coordinate correction method includes a weight acquiring step acquiring information related to a weight of the work piece; a position acquiring step acquiring information related to a position of the work piece on the base; and a correcting step correcting the measurement coordinates of the work piece based on the weight and position of the work piece.

In the present invention, the weight acquiring step, the position acquiring step, and the correcting step correct the measurement coordinates of the work piece. Thus, the measurement coordinates of the work piece can be corrected in light of the deformation of the base corresponding to the position of the work piece on the base and not exclusively from the weight of the work piece. Accordingly, the deformation of the base can be correctly surmised and the measurement accuracy of the work piece can be sufficiently improved.

In the measurement coordinate correction method of the present invention, a plurality of weight sensors are preferably attached to the base, the weight sensors detecting a load from the work piece which is placed on the base. The weight acquiring step preferably acquires information related to the weight of the work piece by calculating the weight of the work piece based on a detected value from each of the plurality of weight sensors. The position acquiring step preferably acquires information related to the position of the work piece by calculating the position of the work piece based on placement positions of the plurality of weight sensors and the detected value from each of the plurality of weight sensors.

When a control device such as a PC (Personal Computer) or any other electronic processing device executes the weight acquiring step, the position acquiring step, and the correcting step, the control device may execute one of the following processes (A) and (B) as the weight acquiring step and the position acquiring step:

(A) In the weight acquiring step and the position acquiring step, the control device acquires information related to each of the weight of the work piece and the position of the work piece on the base, which are input by the user via an inputter such as a mouse or a keyboard.

(B) In the weight acquiring step, the control device calculates the weight of the work piece based on the detected value from each of the plurality of weight sensors attached to the base. Similarly, in the position acquiring step, the control device calculates the position of the work piece on the base based on the placement positions of the plurality of weight sensors and the detected value from each.

In the present invention, the control device executes process (B). Thus, compared with a configuration in which the control device executes process (A), an operation on the inputter in which the user inputs information related to the weight and position of the work piece can be omitted. Convenience is thus improved.

In the measurement coordinate correction method of the present invention, the correcting step preferably includes a deformation amount calculation protocol and a measurement coordinate correction protocol. The deformation amount calculation protocol calculates an amount of deformation of the base at each position on the base based on the weight and position of the work piece. The measurement coordinate correction protocol corrects the measurement coordinates of the work piece based on the amount of deformation of the base.

When the control device such as the PC executes the weight acquiring step, the position acquiring step, and the correcting step, the control device may execute one of the following processes (C) and (D) as the acquiring step.

(C) As preliminary preparation, the weight and position of the work piece placed on the base is changed to various weights and positions, then correction parameters for correcting measurement coordinates for the work piece in each case are calculated and each of the correction parameters is stored in the memory for each weight and position of the work piece. In addition, after the weight acquiring step and the position acquiring step, the control device reads the correction parameters corresponding to the weight and position of the work piece from the memory, then corrects the measurement coordinates of the work piece based on the correction parameters.

(D) After the weight acquiring step and the position acquiring step, the control device calculates an amount of deformation of the base at each position on the base based on the weight and position of the work piece. Then, based on the calculated amount of deformation, the control device corrects the measurement coordinates of the work piece.

In the present invention, the control device executes process (D). Thus, compared with a configuration in which the control device executes process (C), preliminary preparation is unnecessary and time and effort involved in performing the measurement coordinate correction method can be largely reduced.

In the measurement coordinate correction method of the present invention, the correcting step preferably reads the correction parameters corresponding to the weight and position of the work piece from the memory, then corrects the measurement coordinates of the work piece based on the correction parameters.

In the present invention, the control device executes process (C). Thus, compared with a configuration in which the control device executes process (D), there is no need for the control device to calculate the amount of deformation of the base at each position on the base, and thus the processing load on the control device can be largely reduced.

The coordinate measuring apparatus of the present invention is a coordinate measuring apparatus measuring the work piece placed on the base. The coordinate measuring apparatus includes a weight acquirer, a position acquirer, and a corrector. The weight acquirer acquires information related to the weight of the work piece. The position acquirer acquires information related to the position of the work piece on the base. The corrector corrects the measurement coordinates of the work piece based on the weight and position of the work piece. In the present invention, the coordinate measuring apparatus is a device that performs the measurement coordinate correction method described above and thus enjoys effects and results similar to the measurement coordinate correction method described above.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a block diagram illustrating a schematic configuration for a coordinate measuring apparatus according to a first embodiment of the present invention;

FIG. 2 is an overall frame view illustrating a main body of the coordinate measuring apparatus according to the first embodiment of the present invention;

FIG. 3 is a lateral frame view of a portion of the main body of the coordinate measuring apparatus according to the first embodiment of the present invention;

FIG. 4 is a frame view illustrating exemplary placement positions for weight sensors according to the first embodiment of the present invention;

FIG. 5 is a flowchart describing a measurement coordinate correction method according to the first embodiment of the present invention;

FIG. 6 is a frame view to describe an amount of change in pitch according to the first embodiment of the present invention; and

FIG. 7 is a block diagram illustrating a schematic configuration for a coordinate measuring apparatus according to a second embodiment of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### First Embodiment

A first embodiment of the present invention is described below with reference to the drawings.

[Overview Configuration of Coordinate Measuring Apparatus]

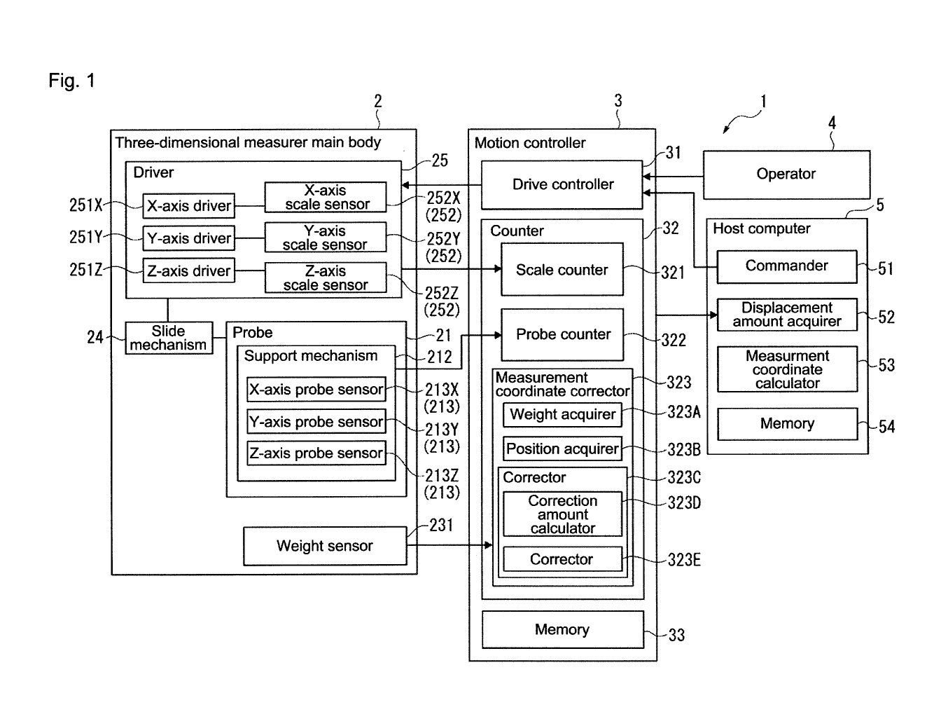

FIG. 1 is a block diagram illustrating a schematic configuration for a coordinate measuring apparatus 1 according to the first embodiment of the present invention. As shown in FIG. 1, the coordinate measuring apparatus 1 includes a coordinate measuring apparatus main body 2; a motion controller 3 exercising drive control of the coordinate measuring apparatus main body 2; an operator 4 providing a command to the motion controller 3 via an operating lever or the like in order to manually operate the coordinate measuring apparatus main body 2; and a host computer 5 providing a predetermined command to the motion controller 3 and executing calculation processes.

[Configuration of Coordinate Measuring Apparatus Main Body]

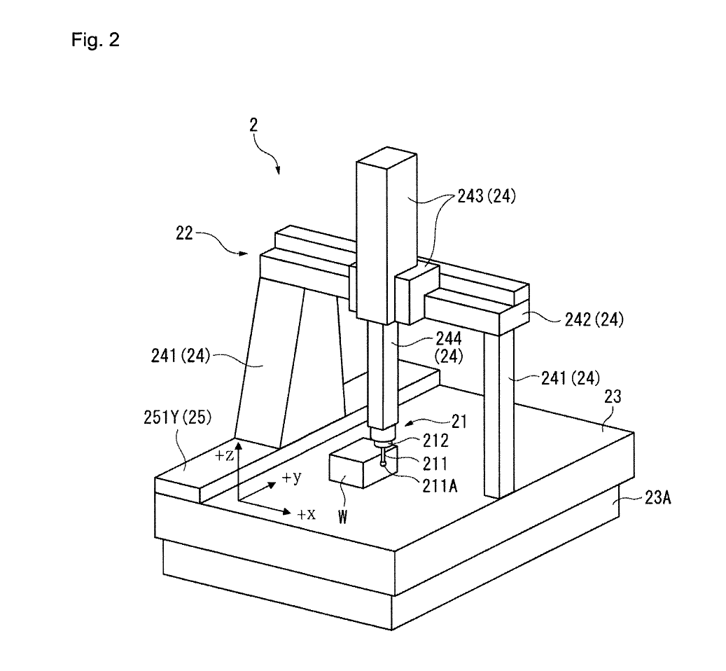

FIG. 2 is an overall frame view illustrating the coordinate measuring apparatus main body 2. Moreover, in FIG. 2, an upward direction is referred to as a +Z-axis direction and two axes orthogonal to the Z axis are referred to as an X axis and a Y axis, respectively. Later drawings use a similar nomenclature. As shown in FIG. 2, the coordinate measuring apparatus main body 2 includes a probe 21, a drive mechanism 22, and a base 23 on which the drive mechanism 22 stands. The probe 21 includes a spherical stylus tip 211A for measuring a work piece W. The drive mechanism 22 holds a base end-side of the probe 21 and drives the probe 21.

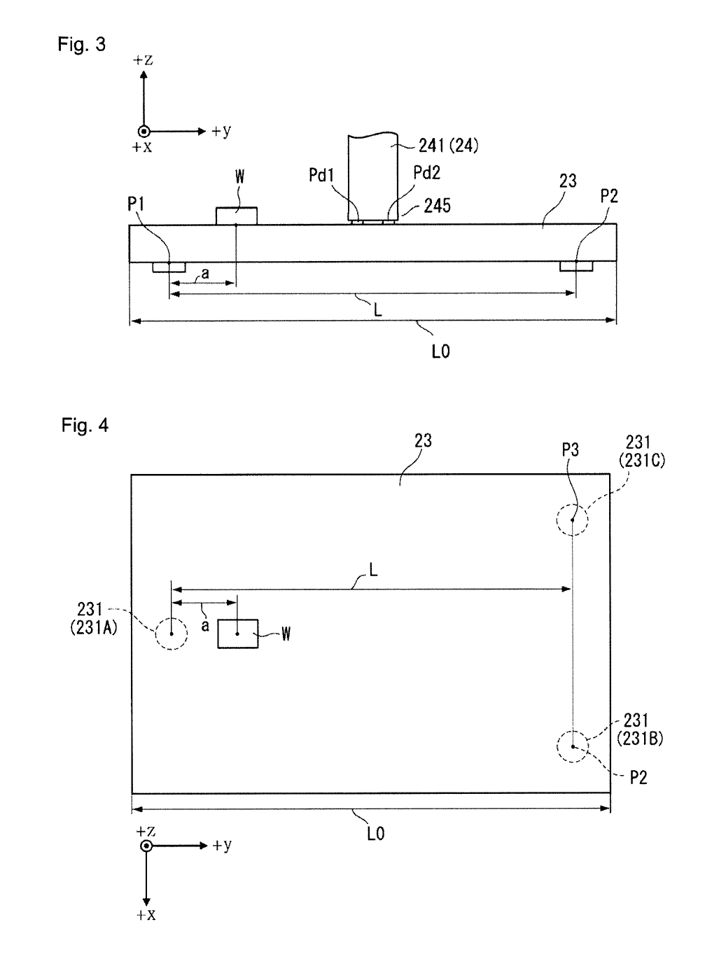

FIG. 3 is a lateral (+X-axis side) frame view of a portion of the coordinate measuring apparatus main body 2. The base 23 is a portion on which the work piece W is placed, and is positioned such that a top surface of the base 23 coincides with the horizontal plane. In addition, as shown in FIG. 3, a plurality of weight sensors 231 are positioned on a bottom surface of base 23, the weight sensors 231 detecting a load from the work piece W placed on the base 23 and outputting a signal corresponding to the detected value to the motion controller 3. The weight sensors 231 may be exemplified by, for instance, a configuration in which a distortion gauge is embedded in the base 23 or an vibration isolating stand 23A (FIG. 2) to detect the load from the work piece W based on an amount of distortion in the base 23 or the vibration isolating stand 23A.

FIG. 4 is a frame view illustrating exemplary placement positions for the weight sensors 231. In the present embodiment, three weight sensors 231 are placed on the bottom surface of the base 23, as shown in FIG. 4. Of the three weight sensors 231, as shown in FIG. 4, a first weight sensor 231A is placed on the bottom surface of the base 23 on a −Y-axis side and in a substantially central X-axis direction position. In contrast, a second weight sensor 231B and a third weight sensor 231C, as shown in FIG. 4, are placed on the bottom surface of the base 23 on a +Y-axis side aligned in the X-axis direction. In addition, as shown in FIG. 4, first to third placement positions P1-P3 for the first to third weight sensors 231A-231C configure an isosceles triangle in which the second placement position P2 and the third placement position P3 create a straight line forming a base side of the triangle.

The drive mechanism 22 holds the base-end side of the probe 21 and additionally includes a slide mechanism 24 enabling displacement of the probe 21 and a driver 25 driving the probe 21 by driving the slide mechanism 24. As shown in FIG. 2, the slide mechanism 24 includes two columns 241, a beam 242, a slider 243, and a ram 244. The two columns 241 extend in the +Z-axis direction from both sides in the X-axis direction on the base 23 and are provided so as to be slide-displaceable along the Y-axis direction. In the present embodiment, as shown in FIG. 3, an air bearing 245 is provided to a −Z-axis-direction end on each of the two columns 241. As shown in FIG. 3, the air bearings 245 include a first air pad Pd1 and a second air pad Pd2 expelling compressed air. By expelling the compressed air from the first and second air pads Pd1 and Pd2, the two columns 241 are supported in a state floating above the base 23.

The beam 242 is supported by each of the columns 241 and extends along the X-axis direction. The slider 243 is provided so as to be slide-displaceable on the beam 242 along the X-axis direction. The ram 244 is inserted into an interior of the slider 243 and is provided so as to be slide-displaceable within the slider 243 along the Z-axis direction. Accordingly, the drive mechanism 22 includes a plurality of drive shafts driving the probe 21 in each of the X-, Y-, and Z-axis directions. The ram 244 holds the base-end side of the probe 21 in a −Z-axis-direction end of the ram 244. Moreover, a plurality of varieties of probes may be prepared and the probe 21 may be selected from among these and held by the ram 244.

The driver 25, as shown in FIG. 1 or FIG. 2, includes X-, Y-, and Z-axis drivers 251X, 251Y, and 251Z. Of the columns 241, the Y-axis driver 251 Y drives the −X-axis direction column 241 along the Y-axis direction. The X-axis driver 251X slides over the beam 242 and drives the slider 243 along the X-axis direction. The Z-axis driver 251Z slides within the slider 243 and drives the ram 244 in the Z-axis direction.

As shown in FIG. 1, each of the X-, Y-, and Z-axis drivers 251X, 251Y, and 251Z includes an X-, Y-, and Z-axis scale sensor 252X, 252Y, and 252Z, respectively, for detecting a position in each axial direction for the slider 243, each of the columns 241, and the ram 244. Moreover, each of the scale sensors 252 is a position sensor outputting a pulse signal corresponding to an amount of displacement of the slider 243, each of the columns 241, and the ram 244.

The probe 21, as shown in FIG. 1 or FIG. 2, includes a stylus 211 (FIG. 1) having the stylus tip 211A at a forefront end-side thereof and a support mechanism 212 supporting the base end-side of the stylus 211. The support mechanism 212 supports the stylus 211 so as to position the stylus 211 in a predetermined position by biasing the stylus 211 in each of the X-, Y-, and Z-axis directions. In a case where an outside force is applied to the stylus tip 211A (i.e., when the stylus tip 211A contacts the work piece W), displacement of the stylus 211 is enabled in each of the X-, Y-, and Z-axis directions within a predetermined range. As shown in FIG. 1, the support mechanism 212 includes an X-axis probe sensor 213X, a Y-axis probe sensor 213Y, and a Z-axis probe sensor 213Z for detecting a position of the stylus 211 in each axial direction. Moreover, each of the probe sensors 213 is a position sensor outputting a pulse signal corresponding to an amount of displacement for the stylus 211 in each of the axial directions, similar to each of the scale sensors 252.

[Configuration of Motion Controller]

As shown in FIG. 1, the motion controller 3 includes a drive controller 31 controlling the driver 25 in response to a command from one of the operator 4 and the host computer 5; a counter 32 counting the pulse signals; and a memory 33 storing the data to be used by the motion controller 3. As shown in FIG. 1, the counter 32 includes a scale counter 321, a probe counter 322, and a measurement coordinate corrector 323. The scale counter 321 gauges the amount of displacement of the slide mechanism 24 by taking a count of the pulse signals output from each of the scale sensors 252. The probe counter 322 gauges the amount of displacement of the probe 21 by taking a count of the pulse signals output from each of the probe sensors 213. The amount of displacement for the slide mechanism 24 and the probe 21 gauged by the scale counter 321 and the probe counter 322, respectively, is output to the host computer 5.

The measurement coordinate corrector 323 corrects an error in the measurement coordinates accompanying deformation of the base 23 when the weighty work piece W is placed on the base 23. As shown in FIG. 1, the measurement coordinate corrector 323 includes a weight acquirer 323A, a position acquirer 323B, and a corrector 323C. The weight acquirer 323A acquires information related to the weight of the work piece W. The position acquirer 323B acquires information related to the position of the work piece W on the base 23.

The corrector 323C corrects the measurement coordinates of the work piece W calculated by the host computer 5 (measurement coordinate calculator 53) based on the weight and position of the work piece W. As shown in FIG. 1, the corrector 323C includes a correction amount calculator 323D and a corrector 323E. Based on the weight and the position of the work piece W, the correction amount calculator 323D calculates an amount of correction for correcting the measurement coordinates of the work piece W calculated by the host computer 5. Based on the amount of correction calculated by the correction amount calculator 323D, the corrector 323E corrects the measurement coordinates of the work piece W calculated by the host computer 5.

[Configuration of Host Computer]

The host computer 5 includes a CPU (Central Processing Unit) and a memory and controls the coordinate measuring apparatus main body 2 by providing predetermined commands to the motion controller 3. As shown in FIG. 1, the host computer 5 includes a commander 51, a displacement amount acquirer 52, the measurement coordinate calculator 53, and a memory 54 storing data to be used by the host computer 5.

The commander 51 provides a predetermined command to the drive controller 31 of the motion controller 3 in order to drive the slide mechanism 24 of the coordinate measuring apparatus main body 2. Specifically, the commander 51 outputs a position command value for driving the stylus tip 211A. Moreover, outline data for the work piece W is stored in the memory 54. The displacement amount acquirer 52 acquires an amount of displacement gauged by the counter 32 for the probe 21 and the drive mechanism 22 (the slide mechanism 24). At this point, the displacement amount acquirer 52 acquires the amount of displacement for the probe 21 based on an orthogonal coordinate system defined by the probe 21 and acquires the amount of displacement for the drive mechanism 22 based on an orthogonal coordinate system defined by the drive mechanism 22.

The measurement coordinate calculator 53 calculates the measurement coordinates of the work piece W (i.e., the position of the stylus tip 211A) based on the amount of displacement for the probe 21 and the drive mechanism 22 acquired by the displacement amount acquirer 52. Moreover, the amount of displacement for the drive mechanism 22 is adjusted so as to indicate the position of the stylus tip 211A when absolutely no displacement of the stylus 211 within the support mechanism 212 occurs (i.e., when the amount of displacement for the probe 21 is 0).

[Measurement Coordinate Correction Method]

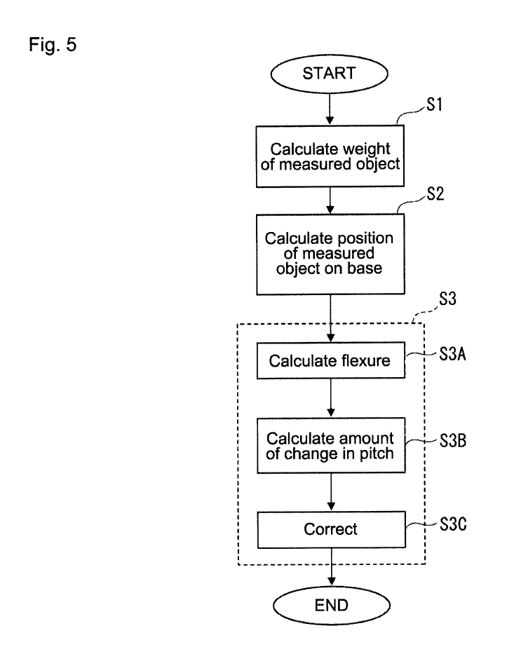

FIG. 5 is a flowchart describing the measurement coordinate correction method. Next, processes of the measurement coordinate corrector 323 (measurement coordinate correction method) are described. Moreover, hereafter, to facilitate description, the measurement of the work piece W placed on the base 23 is treated as complete and the measurement coordinates as already calculated by the measurement coordinate calculator 53. First, the weight acquirer 323A acquires information related to the weight of the work piece W (step S1: weight acquiring step). In the present embodiment, the weight acquirer 323A acquires information related to the weight of the work piece W by inputting signals output from each of the weight sensors 231, then calculating the weight of the work piece W based on the detected values from each of the weight sensors 231. Specifically, the weight acquirer 323A combines the detected values from each of the weight sensors 231 to calculate a weight P of the work piece W.

After step S1, the position acquirer 323B acquires information related to the position of the work piece W on the base 23 (step S2: position acquiring step). In the present embodiment, the position acquirer 323B acquires information related to the position of the work piece W by calculating the position of the work piece W on the base 23 based on the first to third placement positions P1-P3 of each of the weight sensors 231 and on the detected values from each of the weight sensors 231. Specifically, from the memory 33, the position acquirer 323B reads a separation distance L in the Y-axis direction between the first weight sensor 231A and the second and third weight sensors 231B and 231C (FIGS. 3 and 4). Then, using the first placement position P1 of the first weight sensor 231A as a base line, the position acquirer 323B calculates a distance a in the Y-axis direction running from the first placement position P1 to the placement position of the work piece W (FIGS. 3 and 4), based on the separation distance L and the detected values from each of the weight sensors 231. The distance a is calculated as the position of the work piece W.

For example, the weight P, the separation distance L, detected values R1 to R3 from the first to third weight sensors 231 (reactive force for the first to third weight sensors 231A-231C), and the distance a have a relationship described by one of Formula (1) and Formula (2) below.

$$\begin{matrix}[ Formula 1 ] & \\ R 1 = \frac{( L - a )}{L} \cdot P & ( 1 ) \\ [ Formula 2 ] & \\ R 2 + R 3 \frac{\_a}{L} \cdot P & ( 2 )\end{matrix}$$

Thus, the position acquirer 323B uses the relationship described in Formula (1), for example, to calculate the distance a based on the weight P, the separation distance L, and the detected value R1 from the first weight sensor 231A (reactive force for the first weight sensor 231A). Alternatively, the position acquirer 323B uses the relationship described in Formula (2) to calculate the distance a based on the weight P, the separation distance L, and the detected values R2 and R3 from the second and third weight sensors 231B and 231C (reactive force for the second and third weight sensors 231B and 231C).

After step S2, based on the weight P (calculated in step S1) and the distance a (calculated in step S2) of the work piece W, the corrector 323C corrects the measurement coordinates calculated by the measurement coordinate calculator 53 (step S3: correcting step). Specifically, the correction amount calculator 323D calculates the amount of correction (an amount of change in pitch Δp) for correcting the measurement coordinates of the work piece W in steps S3A and S3B, below. First, the correction amount calculator 323D executes the following process in step S3A (deformation amount calculation protocol). Specifically, from the memory 33, the correction amount calculator 323D reads a total length L0 for the base 23 in the Y-axis direction (FIGS. 3 and 4). Then, based on the total length L0, the weight P of the work piece W, and the distance a, the correction amount calculator 323D calculates an amount of deformation (amount of deformation in the Z-axis direction: flexure ω) of the base 23 at a position y in the Y-axis direction, which is based on the first placement position P1 of the first weight sensor 231A. For example, the correction amount calculator 323D calculates the flexure co with Formula (3), below. Moreover, in Formula (3), E is the Young's modulus for the base 23 and I is the second moment of area for the base 23.

$$\begin{matrix}[ Formula 3 ] & \\ ω = \frac{{PL}^{3}}{6 EI} \cdot \frac{y}{L} ( 1 - \frac{a}{L} ) ( \frac{{y}^{2}}{{L}^{2}} - \frac{2 a}{L} + \frac{{a}^{2}}{{L}^{2}} ) & ( 3 )\end{matrix}$$

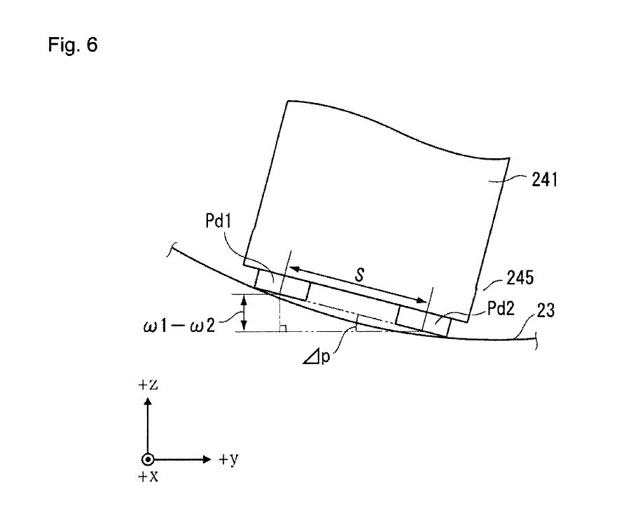

FIG. 6 is a frame view to describe the amount of change in pitch Δp. Specifically, FIG. 6 is a frame view of a portion of the base 23 deformed by placing the work piece W thereon and a portion of the column 241 (air bearing 245) positioned on the base 23, as viewed from a lateral direction (+X-axis side). For ease of description, FIG. 6 illustrates only an upper surface as the base 23. Next, the correction amount calculator 323D executes the following process in step S3B. Specifically, from the memory 33, the correction amount calculator 323D reads a separation distance S (FIG. 6) in the Y-axis direction between the first air pad Pd1 (positioned on the −Y-axis side) and the second air pad Pd2 (positioned on the +Y-axis side). Then, when the column 241 (air bearing 245) is positioned at the position y as viewed from the X-axis direction, the correction amount calculator 323D calculates an angle at which the column 241 is inclined from the horizontal plane based on the separation distance S and the flexure ω. This angle is calculated as the amount of change in pitch Δp (FIG. 6).

For example, the correction amount calculator 323D calculates the amount of change in pitch Δp with Formula (4), below. Moreover, as shown in FIG. 6, in Formula (4), ω1 indicates flexure obtained when the position of the first air pad Pd1 in the Y-axis direction, based on the first weight sensor 231A, is substituted for the position y in Formula (3). In addition, ω2 indicates flexure obtained when the position of the second air pad Pd2 in the Y-axis direction, based on the first weight sensor 231A, is substituted for the position y in Formula (3).

$$\begin{matrix}[ Formula 4 ] & \\ Δ p = \frac{ω 1 - ω 2}{S} & ( 4 )\end{matrix}$$

After step S3B, based on the amount of change in pitch Δp, the corrector 323E corrects the measurement coordinates calculated by the measurement coordinate calculator 53 (step S3C: measurement coordinate correction protocol).

The first embodiment described above has the result described below. In the present embodiment, the measurement coordinates of the work piece W are corrected by the weight acquiring step S1, the position acquiring step S2, and the correcting step S3. Therefore, the measurement coordinates of the work piece W may be corrected in light of not only the weight of the work piece W, but also the deformation of the base 23 in response to the position of the work piece W on the base 23. Accordingly, the deformation of the base 23 may be correctly surmised and the measurement accuracy of the work piece W may be sufficiently improved.

In the present embodiment, the measurement coordinate corrector 323 calculates the weight P of the work piece W based on the detected values from each of the plurality of weight sensors 231 attached to the base 23. In addition, the measurement coordinate corrector 323 calculates the position (distance a) of the work piece W on the base 23 based on the first to third placement positions P1-P3 of the plurality of weight sensors 231 and on the detected values from each. Thereby, compared to a case in which the measurement coordinate corrector 323 is configured to obtain information related to each of the weight of the work piece W and the position of the work piece W on the base 23, which has been input by the user via an inputter such as a mouse or a keyboard, for example, the input operation by the user may be omitted and convenience may be improved.

A method for correcting the measurement coordinates of the work piece W based on the weight P and the distance a of the work piece W may also be the following method. Specifically, as preliminary preparation, the weight and position of the work piece W placed on the base 23 is changed to a variety of weights and positions. The correction parameters for correcting the measurement coordinates of the work piece in each of these cases are calculated, and the correction parameters are stored in the memory 33 for each weight and position of the work piece W. Then, after the weight acquiring step S1 and the position acquiring step S2, the measurement coordinate corrector 323 reads the correction parameters corresponding to the weight P and the distance a of the work piece W from the memory 33. The measurement coordinate corrector 323 then corrects the measurement coordinates of the work piece W based on the correction parameters. In the present embodiment, after the weight acquiring step S1 and the position acquiring step S2, the measurement coordinate corrector 323 calculates the amount of correction (amount of change in pitch Δp) based on the weight P and the distance a of the work piece W, then corrects the measurement coordinates of the work piece W based on the amount of change in pitch Δp. Thereby, the preliminary preparations described above become unnecessary and the time and effort involved in performing the measurement coordinate correction process can be largely reduced.

### Second Embodiment

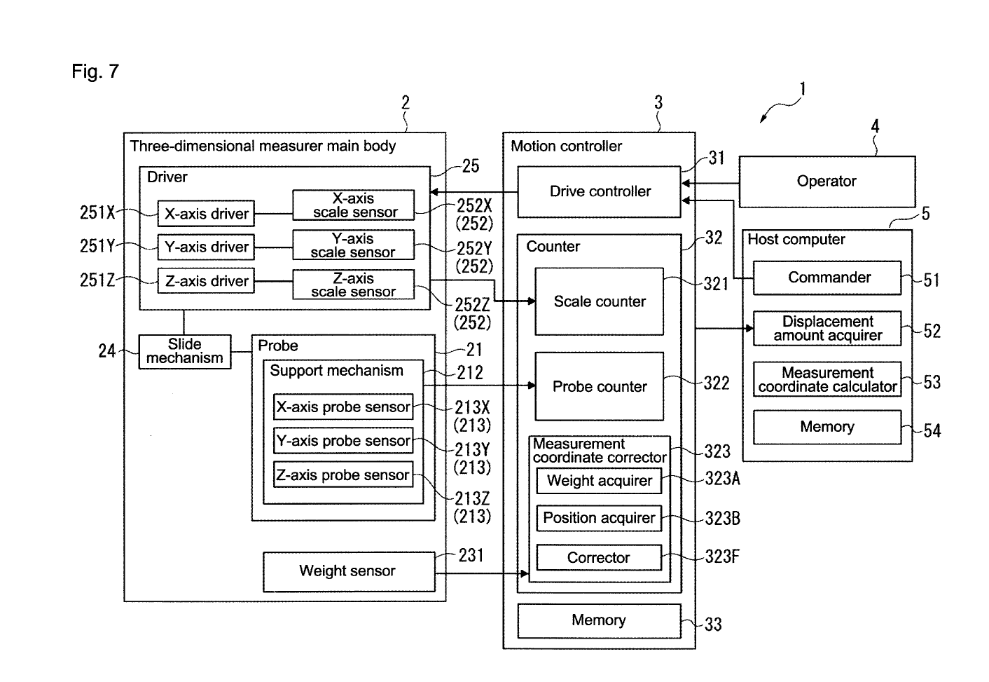

Next, a second embodiment of the present invention is described. FIG. 7 is a block diagram illustrating a schematic configuration of a coordinate measuring apparatus according to the second embodiment. Moreover, structures similar to those in the first embodiment are given the same reference numerals below and a detailed description thereof is omitted. In the first embodiment, the corrector 323C (correction amount calculator 323D) calculated the amount of correction to correct the measurement coordinates of the work piece W based on the weight P and the distance a of the work piece W. The corrector 323C thus corrected the measurement coordinates of the work piece W based on the amount of correction. In contrast, in the present embodiment, by performing the above-described preliminary preparations, the correction parameters for each of the various weights P and distances a for the work piece W are stored ahead of time in the memory 33. Then, in the correcting step S3, a corrector 323F (FIG. 7) reads the correction parameters corresponding to the weight P and the distance a of the work piece W from the memory 33 to correct the measurement coordinates of the work piece W using the correction parameters. Moreover, a similar creation method (FIG. 3) to that of Related Art 1, for example, may exemplify a correction parameter creation method.

According to the second embodiment described above, in addition to effects which are similar to the first embodiment, the following effects are obtained. In the present embodiment, there is no need for the corrector 323F to calculate the amount of correction to correct the measurement coordinates of the work piece W based on the weight P and the distance a of the work piece W in the correcting step S3, and thus the processing load on the host computer 5 can be largely reduced. In addition, when creating the correction parameters during the preliminary preparations, similar to Related Art 1, correction parameters can be calculated in which not only the pitch element but also other geometric errors (e.g., a roll element) can be corrected. In such a case, compared to the first embodiment, the roll element, for example, can be corrected in addition to the pitch element and measurement accuracy can be further improved.

The present invention is not limited to the above-described embodiments and may include modifications and improvements within the scope of achieving the object of the present invention. In each of the embodiments, the weight P and the position (distance a) of the work piece W were calculated based on the detected values from each of the plurality of weight sensors 231. However, the present invention is not limited to this. A user may also input the weight P and the position (distance a) with an inputter such as a mouse or a keyboard. In each of the embodiments, the number and placement positions of the weight sensors 231 are not limited to the number and placement positions described in the various embodiments and may have some other number and placement position. In the first embodiment, only the pitch element (amount of change in pitch Δp) was calculated as the amount of correction to correct the measurement coordinates of the work piece W. However, the present invention is not limited to this. For example, in addition to the pitch element, the roll element may also be calculated and the measurement coordinates of the work piece W may be corrected based on the pitch element as well as the roll element. In the first embodiment, the distance a, the flexure ω, and the amount of change in pitch Δp may be obtained using formulae other than Formulae (1)-(4), above.

The present invention may be used in a coordinate measuring apparatus measuring a work piece placed on a base.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A measurement coordinate correction method correcting measurement coordinates of a work piece placed on a base, comprising:
acquiring weight information related to a weight of the work piece;
acquiring position information related to a position of the work piece on the base; and
correcting the measurement coordinates of the work piece based on the weight and position of the work piece.

2. The measurement coordinate correction method according to claim 1, wherein a plurality of weight sensors are attached to the base, the method further comprising:
detecting, via the weight sensors, a load from the work piece placed on the base, wherein:
said acquiring weight information comprises acquiring information related to the weight of the work piece by calculating the weight of the work piece based on a detected value from each of the plurality of weight sensors; and
said acquiring position information comprises acquiring information related to the position of the work piece by calculating the position of the work piece based on placement positions of the plurality of weight sensors and the detected value from each of the plurality of weight sensors.

3. The measurement coordinate correction method according to claim 1, wherein said correcting the measurement coordinates comprises:
calculating, via a deformation amount calculation protocol, an amount of deformation of the base at each position on the base based on the weight and position of the work piece; and
correcting, via a measurement coordinate correction protocol, the measurement coordinates of the work piece based on the amount of deformation of the base.

4. The measurement coordinate correction method according to claim 2, wherein said correcting the measurement coordinates comprises:
calculating, via a deformation amount calculation protocol, an amount of deformation of the base at each position on the base based on the weight and position of the work piece; and
correcting, via a measurement coordinate correction protocol, the measurement coordinates of the work piece based on the amount of deformation of the base.

5. The measurement coordinate correction method according to claim 1, wherein said correcting the measurement coordinates comprises reading the correction parameters corresponding to the weight and position of the work piece from the memory, then correcting the measurement coordinates of the work piece based on the correction parameters.

6. The measurement coordinate correction method according to claim 2, wherein said correcting the measurement coordinates comprises reading the correction parameters corresponding to the weight and position of the work piece from the memory, then correcting the measurement coordinates of the work piece based on the correction parameters.

7. The measurement coordinate correction method according to claim 3, wherein said correcting the measurement coordinates further comprises reading the correction parameters corresponding to the weight and position of the work piece from the memory, then correcting the measurement coordinates of the work piece based on the correction parameters.

8. The measurement coordinate correction method according to claim 4, wherein said correcting the measurement coordinates further comprises reading the correction parameters corresponding to the weight and position of the work piece from the memory, then correcting the measurement coordinates of the work piece based on the correction parameters.

9. A coordinate measuring apparatus measuring a work piece placed on a base, comprising:
a weight acquirer configured to acquire information related to a weight of the work piece;
a position acquirer configured to acquire information related to a position of the work piece on the base; and
a corrector configured to correct measurement coordinates of the work piece based on the weight and position of the work piece.
